(19) United States
(12) Patent Application Publication
(10) Pub. No.: US 2022/0008997 A1
(43) Pub. Date: Jan. 13, 2022

(54) REGULATION METHOD FOR ADDITIVE MANUFACTURING

(71) Applicant: Siemens Energy Global GmbH & Co. KG, Munich, Bayern (DE)

(72) Inventors: Matthias Goldammer, Munchen (DE); Henning Hanebuth, Pliening OT Gelting (DE)

(73) Assignee: Siemens Energy Global GmbH & Co. KG, Munich, Bayern (DE)

(21) Appl. No.: 17/294,390

(22) PCT Filed: Oct. 28, 2019
(86) PCT No.: PCT/EP2019/079341

§ 371 Date: May 15, 2021

(30) Foreign Application Priority Data
Nov. 22, 2018 (EP) 18207810.5

(51) Int. Cl. B22F 10/80; B33Y 50/00; B33Y 40/10; B22F 12/13; B22F 12/90; G05B 19/4099

(52) U.S. Cl. CPC B22F 10/80; B33Y 50/00; B33Y 40/10; G05B 2219/37431; B22F 12/90; G05B 19/4099; G05B 2219/49023; B22F 12/13

(57) ABSTRACT

A regulation method, corresponding device, and computer program product for the additive manufacturing of a component. The method includes: a) acquiring spatially resolved temperature data for a layer built up additively during the manufacture of the component; b) determining at least one region-of-interest on the layer, which is intended to be processed during the manufacture of the component; c) classifying temperature values of the region-of-interest; d) forming an average value of the classified temperature values; and e) controlling a processing device with the formed average value as the input value in order to process the layer.

### CROSS REFERENCE TO RELATED APPLICATIONS

This application is the US National Stage of International Application No. PCT/EP2019/079341 filed 28 Oct. 2019, and claims the benefit thereof. The International Application claims the benefit of European Application No. EP18207810 filed 22 Nov. 2018. All of the applications are incorporated by reference herein in their entirety.

### FIELD OF INVENTION

The present invention relates to a regulation method for the additive manufacturing of a component, such as in powder-bed-based manufacturing. An apparatus, a computer program product and a method for the additive manufacturing of the component, which uses the regulation described, are also specified.

The component may be intended for use in a turbomachine, in particular in the hot gas path of a gas turbine. The component may consist of a superalloy, in particular a nickel-based or cobalt-based superalloy. The alloy can be, for example, precipitation hardened or solid solution hardened.

### BACKGROUND OF INVENTION

In gas turbines, thermal energy and/or flow energy of a hot gas generated by burning a fuel, for example a gas, is converted into kinetic energy (rotational energy) of a rotor. For this purpose, a flow channel is formed in the gas turbine, in whose axial direction the rotor or a shaft is mounted. If a hot gas flows through the flow channel, a force is applied to the rotor blades and is converted into a torque which acts on the shaft and drives the turbine rotor, wherein the rotational energy can be used, for example, to operate a generator.

Modern gas turbines are the subject of constant improvement in order to increase their efficiency. However, this leads, among other things, to ever higher temperatures in the hot gas path. The metallic materials for rotor blades, especially in the first stages, are constantly being improved with regard to their strength at high temperatures (creep load, thermomechanical fatigue).

Due to its disruptive potential, generative or additive manufacturing is also becoming increasingly interesting for the industrial series production of the above-mentioned turbine components, for example turbine blades or burner components.

Additive manufacturing methods include, for example, as powder bed methods, selective laser melting (SLM) or laser sintering (SLS), or electron beam melting (EBM).

A method for selective laser melting is known, for example, from EP 2 601 006 B1.

Additive manufacturing methods have also proven to be particularly advantageous for complex components or components of complicated or filigree design, for example labyrinth-like structures, cooling structures and/or lightweight structures. In particular, additive manufacturing is advantageous due to a particularly short chain of process steps, since a production or manufacturing step of a component can largely take place on the basis of a corresponding CAD file and the selection of appropriate manufacturing parameters.

The term “computer program product” described herein can represent or include a computer program means, for example, and can be provided or included, for example, as a storage medium, for example a memory card, a USB stick, a CD-ROM, a DVD, or else in the form of a downloadable file from a server in a network. This may take place, for example, in a wireless communication network through the transmission of an appropriate file comprising the computer program product or the computer program means.

An ubiquitous problem with additive manufacturing methods for highly stressed or highly stressable components are the structural properties or material properties which are often inferior to conventional manufacturing techniques. In order to achieve better material properties in additive manufacturing, a further heat source can be used in addition to the laser to better control the heating and cooling behavior. When processing metals, especially superalloys, induction heating systems are suitable for this purpose, but, due to the uneven application of the heating power, additionally require mechanical positioning of the induction coil(s).

The heating power must likewise be controlled, since the geometry has a very strong influence on the heating or the coupling efficiency or effect of the heating. For temperature regulation and/or capture, it is possible to use an infrared camera which overlooks or can capture the entire construction site (of an AM system). The image information can be converted into a temperature via calibration and can be evaluated, for example, at the position of the coils. It is possible that only a fixed position (“region of interest”) within the image is evaluated here and can then be shifted from one position to the next in the image with the coil. This temperature can also be transferred to a regulator or a regulation device with fixed parameters. After a position shift, for example in order to heat a further region of a layer which has been constructed or is to be constructed during the manufacturing of the component, the coil typically reaches another (cold) point and regulates the heating power again.

The regulation used in conventional heating systems often includes a pyrometer which is carried with a coil for inductive heating, is aimed at a fixed, for example through the coil eye, and is regulated with fixed regulation parameters, for example of a PID regulator. The pyrometer by means of via the size of the measurement spot and an evaluation within the measurement spot does not take place.

One problem that arises is that the image from an infrared camera, a thermal imaging camera or a thermographic device does not provide an ideal image, but rather the individual captured “pixels” have a lot of noise. In addition, the temperature in the vicinity of the coil or in the vicinity of the corresponding region of the layer is not constant, but is highly location-dependent or position-dependent. Therefore, on the one hand, the “region of interest” must be chosen to be large enough to cover the relevant region as far as possible. In addition, not only a single pixel (for example the maximum) may be evaluated, since this value fluctuates greatly and this makes regulation more difficult. For stable regulation, there is therefore a need for a solution which, on the one hand, supplies a reliable value close to the maximum within the region of interest, but is not subject to the noise behavior of an individual pixel.

### SUMMARY OF INVENTION

It is therefore an object of the present invention to specify means which solve the problem described above.

This object is achieved by means of the subject matter of the independent patent claims. The dependent patent claims relate to advantageous configurations.

One aspect of the present invention relates to a regulation method or a method for regulating or providing regulation data for the additive manufacturing of a component, in particular powder-bed-based manufacturing.

The method comprises capturing spatially resolved temperature data or temperature values of an additively constructed layer (component layer) during the manufacturing of the component. For this purpose, the data or values mentioned are advantageously captured and/or stored at a plurality of positions of the layer or on the layer.

This layer mentioned can denote one of several hundred or thousand layers which are additively constructed one after the other via powder bed processes by selective irradiation with a laser or energy beam.

The term “during” in connection with the additive manufacturing of the component is intended to mean in the present case that, for example, although a layer is processed overall during the manufacturing of the component, it is advantageously processed by the processing apparatus (in layers) after the respective solidification of the layer.

The method also comprises determining at least one defined region of interest of the layer which is intended to be processed during the manufacturing of the component.

The region or the region of interest advantageously denotes a selected geometric region looking down on the respective constructed layer. The region also expediently denotes a region in which the temperature data are intended to be captured, stored or evaluated. The region of interest is advantageously defined by defined but subsequent processing of the layer, that is to say after the determination, in particular by coordinates of a movable processing device (see further below).

The method also comprises classifying, selecting or dividing temperature values of the at least one region of interest, for example on the basis of at least one defined class of temperature values. This classification can take place in the manner of a histogram, with a set of values being divided into classes based on the class width.

The method also comprises forming a mean value of the classified temperature values. The mean value can be, for example, an arithmetic, a geometric or a quadratic mean value.

The method also comprises controlling or regulating a processing device with the formed mean value as an input value in order to process the layer. The processing can advantageously mean preheating or heating of the layer in the region of interest. In the present case, processing by preheating can also relate to a layer of the component that has not yet solidified or been constructed, but rather to a freshly applied base material layer for the component.

The means described in the present case are advantageously suitable for processing or preheating the component or a component layer to be subsequently manufactured to a temperature of over 1000° C.

In one configuration, the mean value of the classified temperature values is an arithmetic mean value. Alternatively, the mean value can be a geometric or a quadratic mean value.

In one configuration, the mean value is transferred as an actual value to a regulation system or regulation device, in particular comprising a PID regulator, or is used accordingly. Said regulator can be implemented both in terms of software and in terms of hardware.

The method described enables, for example, a simplification compared to temperature regulation in additive manufacturing or another application with a movable pyrometer that is carried along, since the carriage of the pyrometer must be moved from a first position to a second position on the layer, for example.

Nevertheless, the evaluation of the captured temperature values in the region of interest allows, for example, in contrast to the embodiment with a pyrometer, a dynamic or time-dependent evaluation of the individual pixels or temperature values. Such functionality could only be achieved with pyrometers via a combination of a plurality of instruments or systems.

Furthermore, a significantly improved noise behavior can be achieved with the regulation means presented.

In one configuration, the method is a computer-implemented method.

In one configuration, the temperature values or temperature data are captured by means of an infrared camera, a thermal imaging camera or thermographically, for example using appropriate thermographic temperature capture means. This configuration is preferred since many conventional additive manufacturing systems are already equipped with appropriate devices for measuring temperatures or recording temperature images.

In one configuration, the temperature data or values of the layer are captured only in one (or more) region(s) of interest, but not, for example, in other regions of the layer or of the thermal image. This configuration is process-efficient and data-efficient and allows the regulation effort to be minimized.

In one configuration, the temperature values are calculated or determined from the temperature data. The temperature data can deviate from the temperature values to the extent that the temperature data can advantageously describe a temperature or thermal image from which the corresponding specific temperature values first have to be extracted or converted.

In one configuration, a histogram of temperature values is created.

In one configuration, an absolute or relative class frequency of the temperature values is determined for the classification. For the determination or construction of the histogram, the temperature values are divided, selected or classified, for example on the basis or with the aid of a defined class width.

In one configuration, the 10% of the temperature values that are largest, in particular in terms of absolute value, are classified or selected or preselected from the at least one region of interest. This configuration corresponds to that of a histogram in which the areas of the individual rectangles or classes denote the relative class frequencies.

In one configuration, the temperature values are classified or selected, for example preselected, in particular in terms of absolute value, from a range of the largest 10 to, for example, the largest 50 values from the at least one region of interest. This configuration corresponds to that of a histogram in which the areas of the individual rectangles or classes denote the absolute class frequencies.

In the present case, the temperature values mentioned are advantageously cardinally scaling values.

In one configuration, the processing apparatus comprises an induction heating apparatus for preheating the layer.

In one configuration, the processing apparatus comprises a regulation system, in particular a PID regulation system, which receives the mean value as an input value.

In one configuration, a multiplicity of selected areas or regions of interest are determined and/or processed in the additive manufacturing of the component. According to this configuration, the method described can be used particularly expediently and effectively.

In one configuration, the regulation system regulates the induction heating apparatus at least partially continuously, dynamically or as a function of time. This configuration enables particularly precise and rapid regulation of the preheating or processing, with the result that a corresponding additive manufacturing process can be decisively improved with regard to the achievable material structure of the component and the process time.

Another aspect of the present invention relates to an apparatus for controlling the processing device, in particular an induction heating apparatus, which has, for example, two induction coils that can be moved independently of one another. The apparatus comprises means for carrying out the regulation method as described above. These means can be a computer program, a computer program product, a data structure product or other corresponding computer program means.

The apparatus also comprises a temperature capture device, advantageously an infrared camera or a device for thermographically capturing temperature data. In this way, a temperature image of an additively constructed layer can be determined in a particularly simple and expedient manner and temperature data can be captured particularly easily and quickly.

The apparatus also comprises a regulation device, in particular comprising a PID regulator. Alternatively, the regulation can be carried out with a PI regulator, a PD regulator or another regulator or another regulation device.

In one configuration, the apparatus is part of an additive manufacturing system, in particular a system for powder-bed-based additive manufacturing or production.

Another aspect of the present invention relates to a computer program product comprising instructions which, when the program is executed by a computer, cause the computer to carry out at least one of the above-described method steps of the regulation method, i.e. determination, classification, formation of the mean value and/or control. The computer program product can, for example, comprise corresponding computer program means which are required in order to run, for example, corresponding algorithms for solving the problem described.

Another aspect of the present invention relates to a computer-readable medium on which the above-mentioned computer program or computer program product or parts thereof can be stored.

Another aspect of the present invention relates to a method for the additive manufacturing of a component, comprising the layer-by-layer additive construction of the component from a pulverulent base material, wherein, after or during the solidification of a powder layer by means of an energy beam, this layer is processed using the regulation method as described. The particular advantages of the regulation according to the invention are particularly evident in the actual construction process in the material structure of the component which is improved by the heat management.

In one configuration, a temperature capture device or a camera is moved or concomitantly moved from a first position to a second position during the additive manufacturing of the component. The first position can describe a first region of interest. The second position can describe a second region of interest.

In another configuration, at least one region of interest is (concomitantly) moved from a first position to a further or second position, for example by software or program technology, during the additive manufacturing of the component.

Another aspect of the present invention relates to a component which is manufactured or can be manufactured according to the method for additive manufacturing. For example, in contrast to a conventionally manufactured component from the prior art or an additively manufactured component from the prior art, the component comprises a largely crack-free and/or low-stress, in particular monocrystalline and/or columnar crystalline, microstructure.

Configurations, features and/or advantages which in the present case relate to the regulation method, the computer program product or the apparatus can—as explained—also relate to the additive manufacturing process or the component itself, or vice versa.

Further features, properties and advantages of the present invention are explained in more detail below on the basis of exemplary embodiments with reference to the accompanying figures. All of the features described so far and below are advantageous both individually and in combination with one another. It goes without saying that other embodiments can be used and structural or logical changes can be made without departing from the scope of protection of the present invention. The following description therefore should not to be interpreted in a restrictive sense.

The term “and/or” used here, when used in a series of two or more elements, means that any of the listed elements can be used alone, or any combination of two or more of the listed elements can be used.

### BRIEF DESCRIPTION OF THE DRAWINGS

FIG. 1 shows a schematic sectional view of a component during its additive manufacturing.

FIG. 2 shows a schematic plan view of a component cross section which is processed with a processing device.

FIG. 3 indicates, by way of example, a histogram of captured temperature values of a layer, which is greatly simplified for the sake of clarity.

FIG. 4 uses a schematic plan view of a solidified component layer to indicate a sequence of a plurality of processing steps.

FIG. 5 shows a simplified flowchart for illustrating method steps of the method described.

### DETAILED DESCRIPTION OF INVENTION

In the exemplary embodiments and figures, identical or identically acting elements can each be provided with the same reference signs. The elements shown and their proportions to one another are fundamentally not to be regarded as true to scale; rather, individual elements can be shown exaggeratedly thick or with large dimensions for better presentability and/or for better understanding.

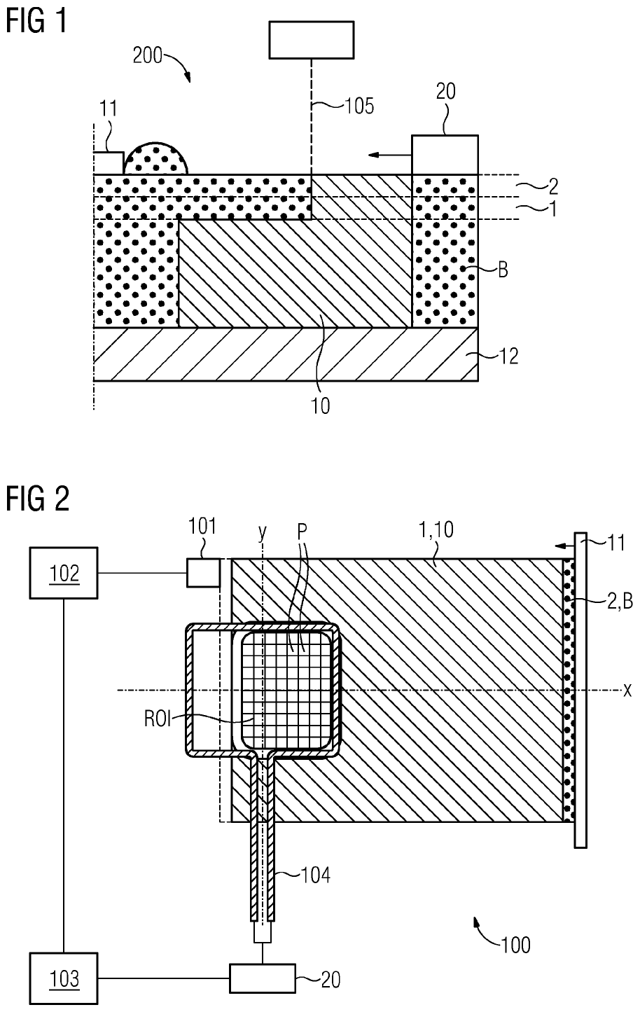

FIG. 1 uses a schematic sectional view to indicate the additive manufacturing of a component 10 from a powder bed, advantageously by means of selective laser melting or electron beam melting. A corresponding additive manufacturing system is identified with the reference sign 200.

A starting or base material B for the component 10 is selectively irradiated and solidified in layers by an energy beam, advantageously a laser beam 105, in accordance with the desired (predetermined) geometry. For this purpose, the component is manufactured on a substrate or a construction platform 12 or welded to it.

The platform 12 simultaneously serves as a mechanical support during manufacturing in order to protect the component from thermal distortion. After the solidification of each layer, a manufacturing surface (not explicitly identified) is newly coated with powder B, advantageously by a coater 11, and the component is constructed further in this way. Layers 1 and 2 are indicated by dashed lines in FIG. 1 merely by way of example, the layer thickness of which in such processes is usually between 20 and 80 μm.

The component 10 is advantageously a component which is used in the hot gas path of a turbomachine, for example a gas turbine. In particular, the component can be a rotor or guide blade, a segment or ring segment, a burner part or a burner tip, a frame, a shield, a heat shield, a nozzle, a seal, a filter, an orifice or lance, a resonator, a stamp or an agitator, or a corresponding transition, insert, or a corresponding retrofit part. Accordingly, the component 10 is advantageously a component that is thermally and/or mechanically highly stressed in its intended operation and is made of a superalloy, for example a cobalt-based or nickel-based superalloy.

A processing device 20 is also indicated on the right-hand side of a manufacturing surface (on the right in the figure). The processing device 20 can be used to expediently be pretreat and/or post-treat a newly applied powder layer or a freshly solidified or irradiated component layer. This processing is particularly advantageous or expedient in order to carry out an advantageous or necessary heat treatment (heat management) of the corresponding components, advantageously in-situ and/or during construction.

The large process-inherent temperature gradients in powder-bed-based processes often exceed 10⁴ K/s and accordingly cause high chemical imbalances, cracks and/or mechanical stresses. It is therefore expedient, for example, to thermally process a newly applied powder layer (see reference sign 2) or an already fully solidified component layer (see reference sign 1) with a processing device (see reference sign 20).

The means described in the present case for the processing or the processing device 20 are advantageously suitable for heating a processing or preheating of the component 10 or a component layer 2 to be subsequently manufactured to a temperature of over 1000° C.

FIG. 2 shows a schematic plan view of a layer 1 freshly irradiated with the energy beam 105 and solidified. As in FIG. 1, a coater 11 or a coating device 11 can be seen here, which is configured to apply new powder B for a layer to be subsequently irradiated (see reference sign 2 in FIG. 1). The coater 11 is advantageously movable in the X direction along a construction surface and can be moved back and forth to apply new powder B in order to distribute powder, for example from a powder supply (also not explicitly identified), on a manufacturing surface.

According to the illustration in FIG. 2, the cross section of the component 10 is only shown in a rectangular shape for the sake of clarity. In the case of components for which additive manufacturing is offered or worthwhile, this is of course often not the case, and the component cross section can have a complicated geometry, for example a geometry which is not closed or has cavities.

In contrast to FIG. 1, according to the present invention, it is possible to see a processing device 20 which advantageously comprises or represents an inductive heating device. Alternatively, the processing device can introduce heat into a component layer using a different principle, for example.

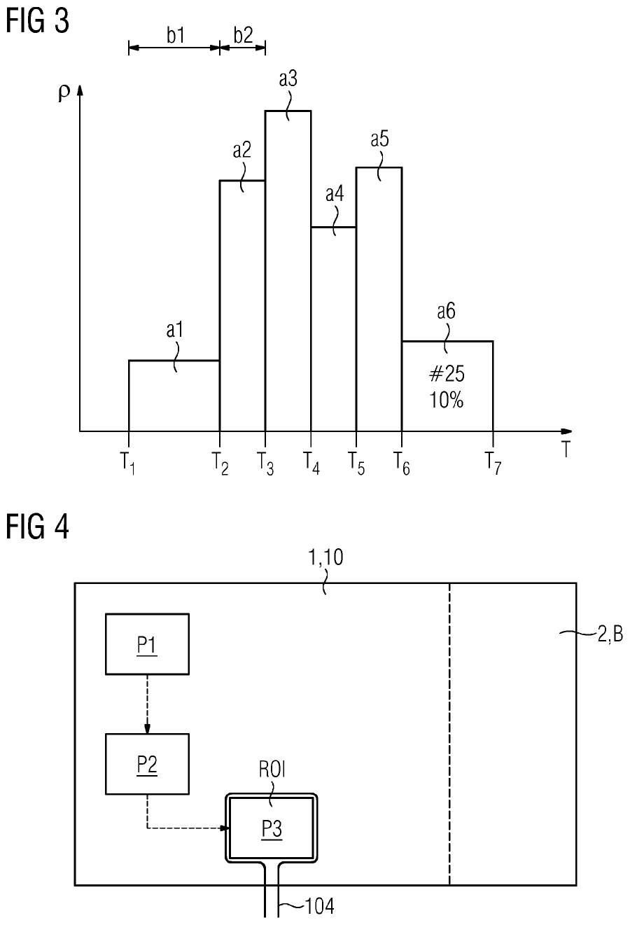

A conventional additive manufacturing system (see reference sign 200 in FIG. 1) advantageously comprises a temperature capture device 101, advantageously an infrared camera, which can be used to record, for example for each irradiated layer, a complete temperature image of the layer or of the manufacturing surface. An item of image information relating to a pixel (see FIG. 2) from the temperature image can, for example, be converted into a temperature value via calibration and can be evaluated at corresponding positions of later processing (see FIG. 3 further below).

Via a computer 102 or a data processing device and advantageously also a regulation device 103, captured temperature data, advantageously said temperature or thermal image of the layer 1, can be stored and transferred to the processing device 20 or this can be controlled accordingly.

An apparatus 100 can accordingly be configured to control the processing device 20 and can also comprise said computer program means (see reference sign CPP further below), the temperature capture device 101, the computer 102 and, for example, the regulation device 103. Accordingly, the apparatus 100 can be coupled or connected to the processing device 20.

In the embodiment shown in FIG. 2, the processing device 20 has an inductive heating device or an induction coil 104. Although this is not explicitly shown, the device 20 can also have a plurality of induction coils, for example a coil arranged displaceably or movably along the X direction and a coil arranged displaceably or movably along the Y direction. The coils mentioned can also be superimposed in such a way and without disruption or independently of one another that desired or predefined heating, for example heating of over 1000° C., can be achieved only in a selected region (cf. “region of interest” and reference sign ROI).

The “region of interest”, which is shown by way of example on the left in FIG. 2, can also correspond to the region of a “coil eye” and can thus represent a region in which particularly precise temperature monitoring and regulation is required in order to achieve an advantageous structure of the layer 1 or of the component 10. The region ROI is divided into a multiplicity (approx. 80) of pixels P in FIG. 2 by means of grid lines. This division is still only an example. In a real application of the described method or the described apparatus, the region of interest can comprise several hundred temperature values, for example 200, 300, 400 or 500 temperature values; or this number of values can be captured therein by the temperature capture device 101.

According to the present invention, temperature data or temperature values T of the layer 1 are correspondingly captured and/or stored in a spatially resolved manner by the temperature capture device 101.

The region of interest can be determined, for example, by (predefined) positions or position data of the processing device, more precisely of the induction coil 104 or its “eye”.

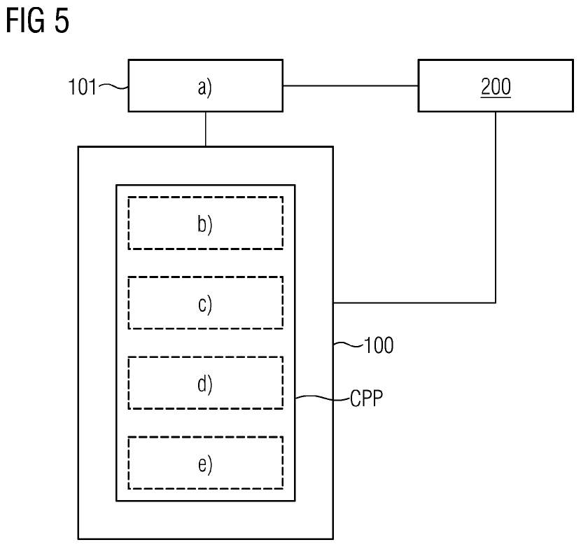

Instead of, for example, carrying a pyrometer for capturing the temperature of or processing the layer 1 to a multiplicity of positions (see FIG. 4 further below) and aiming it at a fixed point within the coil eye and capturing the temperature there merely at a point pyrometrically, as is customary in the prior art, temperature values of the region of interest are now classified according to the present invention. This can be done in a similar way to the construction of a histogram (see FIG. 3 further below).

Corresponding temperature values or pixels P, in particular, are captured on the basis of the temperature image captured by the temperature capture device. This can be done by means of calibration or corresponding conversion of image data into temperature values. The captured temperature values T in the region of interest are now classified, advantageously automatically or in a computer-implemented manner, based on the required regulation quality and efficiency.

For expedient temperature regulation in the context described, it is furthermore most expedient to provide a reliable value or mean value for a maximum temperature within the region of interest. Therefore, in one advantageous configuration of the present invention (see also FIGS. 3, 4 and 5 further below), the 10% of the captured temperature values which are the largest in terms of absolute value are classified or used for further regulation. Alternatively, for example, it is also possible to select the 10, 20, 30, 40 or 50 values which are the largest in terms of absolute value or other values from the region of interest, for example the 25 largest temperature values.

For the sake of simplicity, only one coil 104, which can heat a region ROI to be selected in a predefined manner, is identified in FIG. 2. The coil 104 is arranged to be movable and displaceable along the X direction. In the same way, it is possible to provide a similar coil so as to be movable along the Y direction, such that the selected region ROI can be heated in a focused and expedient manner by both coils.

The processing device 20 is also advantageously configured to be moved, through its movability, over any positions above the powder bed or the layer surface in such a way that both an already solidified component layer (see layer 1) and a layer of newly applied base material or powder (see layer 2) can be heated. In contrast to the solid component structure, however, heating of the powder (see on the left in FIG. 2) is negligible, and the heating power absorbed is dominated by the already solidified layers at the bottom. In the SLM method, these layers are generally significantly thinner than the penetration depth of the induction field or the magnetic flux of the coil(s) 104 that induces the eddy currents.

FIG. 3 shows a schematic, simplified histogram with classified temperature values of the layer 1 or of the component 10.

Temperature values T, which advantageously correspond to captured temperatures or temperature values from the region of interest (see FIG. 2), are plotted on the abscissa.

In particular, six temperature classes are classified or divided by way of example and in a simplified manner; a first temperature class between T1 and T2, a second temperature class between T2 and T3, a third temperature class between T3 and T4, a fourth temperature class between T4 and T5, a fifth temperature class between T5 and T6 and a sixth temperature class between T6 and T7. It is also shown by way of example that the class widths (compare, for example, b1 for the first temperature class and b2 for the second temperature class) of the second, third, fourth and fifth temperature classes are the same and are half as large as the class widths of the first and sixth temperature classes.

In the present case, the different class widths can be, for example, only one or more tenths of a degree Celsius.

The area of the rectangles (compare, for example, a1 for the first temperature class and a2 for the second temperature class), which respectively denotes the relative or absolute class frequency, corresponds to the product of the respective class width bₙ and the frequency density ρ. Correspondingly, the frequency density ρ is plotted on the ordinate of the histogram.

The class frequency reflects either an absolute or a relative value. The absolute value corresponds to the number of values that belong to a class. The relative value, on the other hand, expresses what percentage of the values belong to a class.

As indicated above with reference to the description of FIG. 2, the 10% of the temperature values which are the largest (in terms of absolute value) and are captured from at least one region of interest in each case can be used to form the mean value, for example. Alternatively or additionally, the 10, 20, 30, 40 or 50 absolute values which are the largest (in terms of absolute value), advantageously the 25 largest values, can also be used, for example. Accordingly, the temperature values of the sixth temperature class (with class frequency a6) of the histogram have a greater significance for the present application of the regulation method than, for example, the temperature values of temperature class 1 of class frequency a1. For a different application or the same application, however, further temperature classes can also represent a valuable input for the temperature regulation in order to optimize the processing of the layer or the component 10 during manufacture.

The captured temperature data can be divided or classified, for example, by means of machine optimization methods, for example representing or comprising artificial neural networks or genetic or evolutionary algorithms.

According to the present invention, a mean value, advantageously the arithmetic mean value, of the classified temperature values is now formed. This value can then be used to subsequently control or regulate the processing device 20 as an actual or input value, for example in order to process the layer 1 (see FIG. 1). Advantageously, the use of the mean value of the classified values makes it possible to provide a robust and accurate regulation system which has a significantly improved noise behavior (increased signal-to-noise ratio) than, for example, when evaluating an individual pixel with a pyrometer, which, as indicated above, evaluates only a measurement spot within the region of interest, for example.

The noise can be reduced by transmitting or capturing an item of information multiple times. Since noise occurs stochastically, the standard deviation of the noise signal, for example, also increases only by the factor \sqrt{n} when n transmissions are added, whereas the signal increases by the factor n. The signal-to-noise ratio related to the signal amplitude increases by \sqrt{n}.

FIG. 4 shows, on the basis of a representation similar to the representation in FIG. 2, a sequence of processing steps, on the basis of which a solidified component layer 1 is processed, advantageously inductively heated, advantageously immediately, after solidification by means of the processing device 20 described. According to the invention, the processing device 20 is therefore advantageously regulated or controlled with the mean value formed as the input value.

The mean value can accordingly denote an actual value for a PID regulator which can function as a regulation device 103. The regulation device, for example having a PI, PD or PID regulator, can be configured using software and hardware, for example, and can be executed on the computer 102 or another programmable device, for example.

For example, a heat treatment tailored to the alloy of the component may be necessary or advantageous, for example, in order to relieve tension in the component, avoid or prevent hot cracks or to prevent large process-inherent temperature gradients which in turn prevent cracks, chemical imbalances or, in principle, weldability of the base material.

The corresponding processing regions (compare ROI at positions P1, P2 and P3 in FIG. 3) can be, for example, those positions which are also irradiated one after the other according to an irradiation strategy. Alternatively, they may be specially selected regions, for example regions in the layer which are particularly susceptible to structural defects or other factors, for example strength-related factors. The positions can also—unlike in FIG. 3—merge continuously or steadily into one another.

Typically, after processing a first position P1, the coil 104 or the processing device 20 is moved to a subsequent second position P2 and/or to a subsequent third position P3, which then indicates a not yet heated or cold point, and can be processed, for example, in a corresponding ROI of the position. Instead of three positions and/or ROIs, as indicated in FIG. 3, in reality, for example, several hundred or thousand positions can be approached and/or processed per layer.

The temperature capture device 101, like the processing device 20, can be concomitantly moved from one position to the next in this case. However, this is not absolutely necessary. With suitable positioning, only a single temperature image of the layer can also be sufficient to successfully carry out the processing on the basis of the captured temperature values. The region of interest can then be shifted from a first position to a further or second position, for example simultaneously with the movement of the processing device 20, using data, software or program technology, for example, during the additive manufacturing of the component. In other words, only a corresponding measurement region can accordingly be shifted (virtually).

According to the present invention, the temperature data, as described above, are stored and/or captured at different positions of the additively constructed layer 1, advantageously in the determined regions of interest ROI (compare method steps a) and b) further below); rather than, for instance, within the entire recorded temperature image. Furthermore, the temperature values can be stored and/or captured during the processing of the layer, for example along the positions P1 to P3 as a function of the position or per ROI.

The regulation of the temperature or the processing of the layer 1 with the processing device 20 can still be carried out quasi-continuously in the present case. In particular, a dense sequence of images from the infrared camera, which can capture for example data or images at 50 Hz, can be used for quasi-continuous or time-dependent regulation; and this per region of interest and for each additively constructed layer or layer to be additively constructed.

FIG. 5 shows a schematic flowchart which indicates that method steps of the described method can be carried out, for example, individually or cumulatively according to the present invention by a computer program or in a computer-implemented manner. In particular, the steps of determining the region of interest b), classifying the temperature values c), forming the mean value d) and controlling e) can be carried out using program technology. This is indicated in FIG. 5 by the computer program product CPP. The computer program product or computer program can also be part of the apparatus 100 which in turn can be coupled to the processing device 20 and/or to the additive manufacturing system 200 or connected to it. Furthermore, the computer program product CPP can possibly be read into a processor or a computer of the manufacturing system 200.

The invention is not restricted by the description based on the exemplary embodiments to these exemplary embodiments, but rather encompasses any new feature and any combination of features. This includes in particular any combination of features in the patent claims, even if this feature or this combination itself is not explicitly specified in the patent claims or exemplary embodiments.

1. A regulation method for the additive manufacturing of a component, comprising:
a) capturing spatially resolved temperature data relating to an additively constructed layer during the manufacturing of the component,
b) determining at least one region of interest of the layer which is intended to be processed during the manufacturing of the component,
c) classifying temperature values of the region of interest,
d) forming a mean value of the classified temperature values, and
e) controlling a processing device with the formed mean value as an input value in order to process the layer,
wherein the processing apparatus is an induction heating apparatus for preheating the layer and comprises a regulation system which receives the mean value as an input value.

2. The method as claimed in claim 1,
wherein the temperature data are captured by means of an infrared camera or thermographic ally.

3. The method as claimed in claim 1,
wherein the temperature data are captured only in a “region of interest” of the layer, and
wherein the temperature values are calculated or determined from the temperature data.

4. The method as claimed in claim 1,
wherein a histogram of temperature values is created and—for the classification—an absolute or relative class frequency of the temperature values is determined.

5. The method as claimed in claim 1,
wherein the largest 10% of the temperature values are classified or selected from the at least one region of interest.

6. The method as claimed in claim 1,
wherein temperature values are classified or selected from a range of the largest 10 to the largest 50 values from the at least one region of interest.

7. The method as claimed in claim 1,
wherein the mean value of the classified temperature values is an arithmetic mean value.

8. The method as claimed in claim 1,
wherein a multiplicity of regions of interest are determined and/or processed in the additive manufacturing of the component.

9. The method as claimed in claim 7,
wherein the regulation system continuously regulates the induction heating apparatus.

10. The method as claimed in claim 1,
which is a computer-implemented method.

11. An apparatus for controlling a processing device, comprising:
means for carrying out the steps of the method as claimed in claim 1,
a temperature capture device,
a computer, and
a regulation device, in particular a PID regulator.

12. The apparatus as claimed in claim 11,
which is part of an additive manufacturing system.

13. A non-transitory computer readable media, comprising:
instructions which, when executed by a computer, cause the computer to carry out the method as claimed in claim 1.

14. A method for the additive manufacturing of a component, comprising:
layer-by-layer additive construction of the component from a pulverulent base material,
wherein, after or during the solidification of a powder layer by an energy beam, this layer is processed with the processing device using the method as claimed in claim 1.

15. The apparatus as claimed in claim 11,
wherein the apparatus comprises an inductive heating device.

16. The apparatus as claimed in claim 12,
wherein the additive manufacturing system comprises a system for powder-bed-based additive manufacturing.
